(19) United States
(12) Patent Application Publication
(10) Pub. No.: US 2011/0099062 A1
(43) Pub. Date: Apr. 28, 2011

(54) Sponsorship Advertisement Network

(75) Inventor: Adam Sah, San Francisco, CA (US)

(73) Assignee: GOOGLE INC., Mountain View, CA (US)

(21) Appl. No.: 12/615,995

(22) Filed: Nov. 10, 2009

Related U.S. Application Data
(60) Provisional application No. 61/255,086, filed on Oct. 26, 2009.

(51) Int. Cl. G06Q 30/00

(52) U.S. Cl. 705/14.49; 705/14.69; 705/14.73

(57) ABSTRACT

Methods, systems, and apparatus, including computer programs encoded on a computer storage medium, for a sponsorship advertisement network. In one aspect, a method includes providing to a publisher a display element of a sponsored publisher for display on a page of the publisher, wherein a sponsor sponsors the sponsored publisher and the display element includes content of the sponsored publisher.

### CROSS-REFERENCE TO RELATED APPLICATION

Under 35 U.S.C. §119, this application claims benefit of pending U.S. Provisional Application Ser. No. 61/255,086, filed Oct. 26, 2009, the entire contents of which are hereby incorporated by reference.

### BACKGROUND

The present disclosure relates to online advertising networks.

An advertising network connects websites that want to host advertisements with advertisers who want to place advertisements. Online advertising inventory comes in many different forms. This inventory can be found on websites, in Really Simple Syndication (RSS) feeds, on blogs, in instant messaging applications, in adware, in e-mails, and in other sources. Some examples of advertising inventory include: banner ads, rich media, text links, and e-mails. Advertising networks can deliver their content through the use of a central advertisement (“ad”) server. In one type of advertising network, known as a blind network, advertisers place ads, but do not know the exact places where their ads are being placed. Large advertising networks can include a mixture of search engines, media companies, and technology vendors.

### SUMMARY

In general, one aspect of the subject matter described in this specification can be embodied in a method that includes receiving data for a sponsor including campaign parameters and identification of a sponsored publisher; associating the sponsor with a display element and providing to a first publisher the display element for display on a page of the first publisher, wherein the display element does not include content of the sponsor; receiving an indication of selection of the associated display element at a user device displaying the first publisher page and the display element in the first publisher page; and providing to the user device, in response to receiving the indication, a first sponsored page of the sponsored publisher selected based on the campaign parameters, the first sponsored page including data that causes the content of the sponsor to be displayed on the user device. Other embodiments of this aspect include corresponding systems, apparatus, and computer program products.

These and other embodiments can optionally include one or more of the following features. The campaign parameters can include a reference to an account, the method further comprising updating the account to reflect a cost for providing the display element. An indication of selection of a different display element presented on a different publisher's page can be received, and in response not updating the account to reflect a cost for providing the different display element. The displayed first sponsored page can be an interstitial page. The first sponsored page can include content of the sponsored publisher. The first sponsored page can include content of a different second sponsor and content of the sponsored publisher. The campaign parameters can specify a level of sponsorship. Providing to the user device the first sponsored page can comprise determining a format of the first sponsored page based on one or more of the campaign parameters associated with the sponsor. The content of the sponsor can be a trademark or a service mark.

Particular embodiments of the subject matter described in this specification can be implemented so as to realize one or more of the following advantages. Website sponsorships can be accepted without accepting advertising. Web traffic is driven to sponsored publishers, while giving sponsorship money to “long tail” websites, blogs, etc., in terms of payment for ad placement, which are too small to attract big brand sponsors. Unlike traditional sponsorship programs, ad-like content may not be shown for organic user traffic on the sponsored website. Allows users who do see sponsorship messages on the sponsored publisher's website to easily opt-out, either by sponsor, or for the entire website. The system is scalable to large numbers of sponsors and allows competitors to sponsor the same website.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A illustrates an example user interface including a sponsored advertisement.

FIG. 1B illustrates an example user interface for a sponsored page.

FIG. 2A is a schematic diagram of an example of website sponsorship.

FIG. 2B illustrates an example interstitial page for a sponsor.

FIG. 2C illustrates an example co-sponsored page.

FIG. 3 is a block diagram of an example environment in which a sponsorship system can be implemented.

FIG. 4 is a flow diagram of an example technique for sponsorship of a publisher.

Like reference numbers and designations in the various drawings indicate like elements.

### DETAILED DESCRIPTION

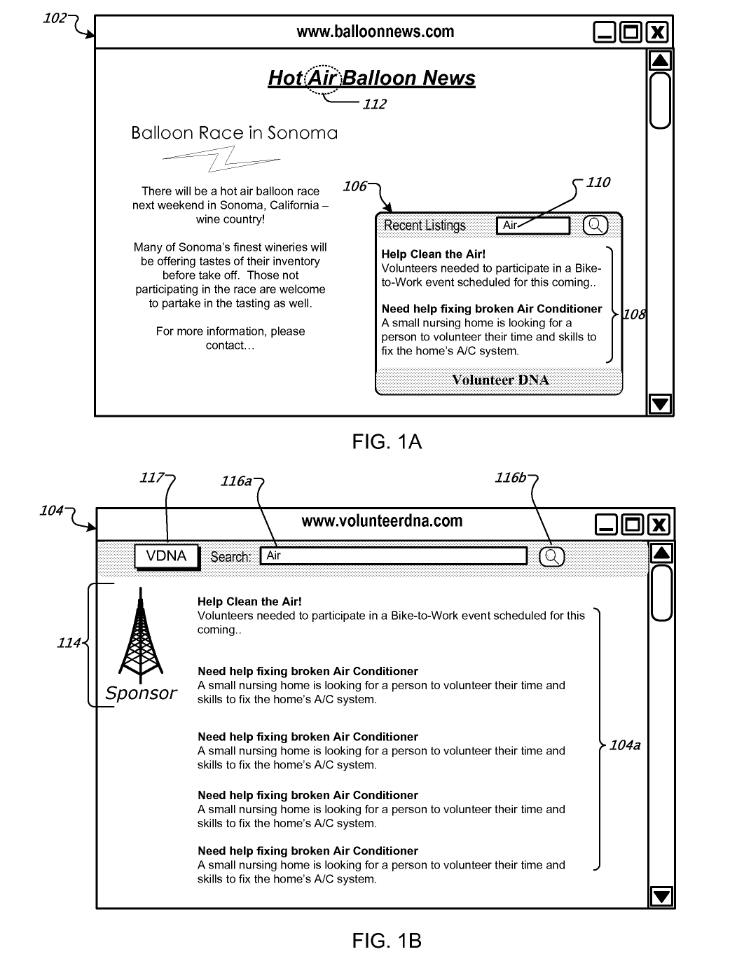

FIG. 1A illustrates an example graphical user interface, such as page 102, that includes a sponsored advertisement or display element 106 as presented on a user device such as a personal computer or a mobile telephone, for example. Pages can be displayed by web browsers, mobile application programs, or other applications. In some implementations, a page is an Internet addressable resource such as, for instance, an HTML document. In further implementations, a page is a region of a graphical user interface displayed by an application program. Other types of pages are possible, however.

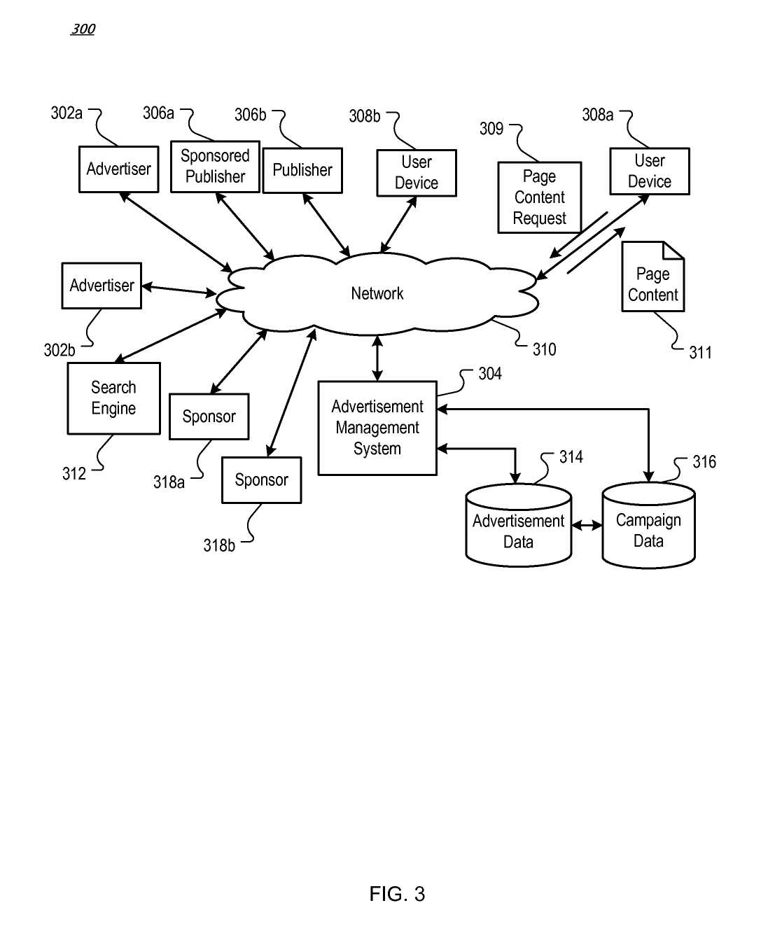

A sponsor financially, or through products or services, supports a publisher (a so-called “sponsored publisher”). For example, the sponsored publisher might be a not-for-profit organization that has little revenue available for advertising its website. A sponsored publisher creates content for a web property or website that, in some implementations, includes the sponsor's brand, brand message, or other sponsor content, for instance. A sponsored publisher can be sponsored by more than one sponsor. In order to drive web traffic to its website, the sponsored publisher places display elements such as display element 106 on other publishers' websites through an ad network or by other means (see FIG. 3 and the accompanying discussion below). The sponsored publisher can use financial support from its sponsors in order to purchase ad space on other publishers' websites. In some implementations, the display element 106 is tailored to the ad network, the other publisher's websites, demographics, or combinations of these.

The display elements, when selected, cause the sponsored publisher's website to be presented (e.g., in a web browser). In some implementations, the display elements do not contain content of the sponsor. This allows the display elements to be placed on websites that the sponsor would not ordinarily consider appropriate for their brand since there is no association in a consumer's mind between the website that the display element 106 appears on and the sponsor, whose content appears on the sponsored publisher's website. As a result, display elements can be placed on websites that charge less for ads (so-called “long tail” websites) without concern that the sponsor will be associated with those websites.

By way of illustration, page 102 includes a display element 106 which in this illustration is a context-aware gadget ad (CGA) that selects a word or phrase in the page 102 content, such as the word “Air” 112, submits the word 110 to a search engine (e.g., the sponsored publisher), and then displays results 108 that are responsive to the search. A CGA can be implemented by JavaScript or other code included in the page 102, for example. Other types of display elements are possible, including those that are described below in reference to FIG. 3. In the illustrated implementation, the display element 106 does not include any sponsor content. Users can select the display element 106 such as, for example, by clicking on it with a mouse, touching a display device or a touch-sensitive surface, issuing a voice command, performing a gesture, or in other ways. In some implementations, selection of the display element 106 causes the sponsored publisher's page 104 (FIG. 1B) to be presented. The display element 106 can implement an event handler that catches the user interface selection event and in response causes the user's web browser to load the sponsored publisher's page 104, for example. The sponsored publisher's page 104 includes content of the sponsored publisher 104a, which in this illustration is a not-for-profit search engine for finding volunteers, and content of the sponsor (e.g., sponsor brand 114). Other possible configurations of the sponsored publisher's page are described below.

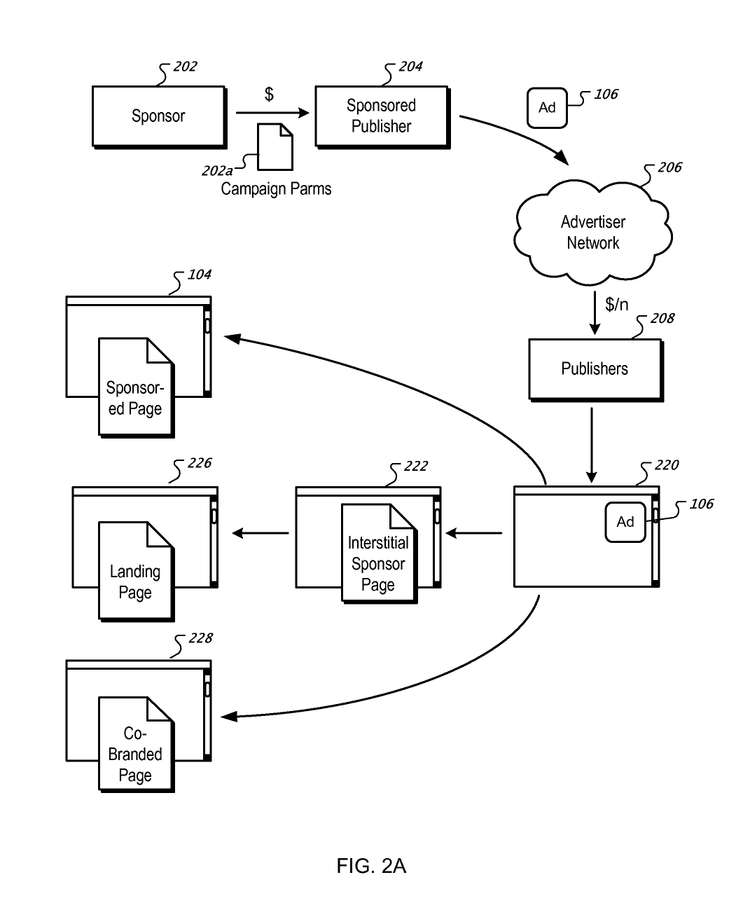

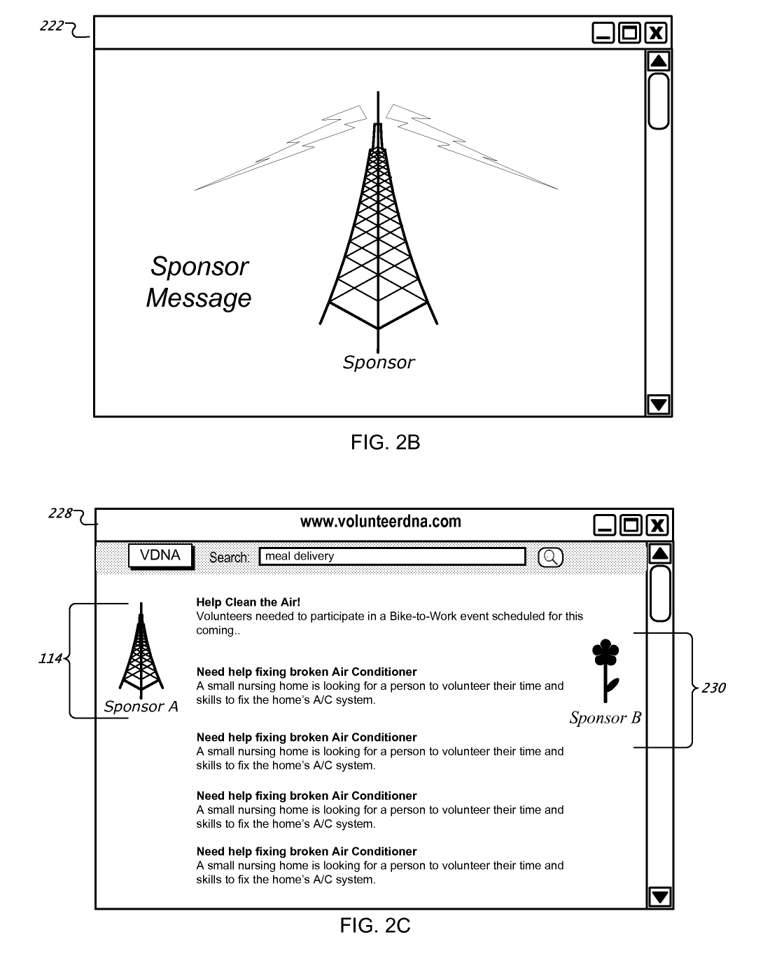

FIG. 2A is a schematic diagram of an example of website sponsorship. A sponsor 202 provides financial support and, optionally, campaign parameters 202a to a publisher 204. The campaign parameters 202a specify the type of sponsorship, among other things. The financial support is used by the sponsored publisher 204 to purchase advertisement impressions for display elements (e.g., 106) on one or more (n) other publishers 208 directly or through one or more ad networks 206. The financial support of sponsors gives sponsored publishers the budget needed to drive traffic to their websites. This budget can be stretched by placing adds on “long tail” websites which charge less for advertising.

In some implementations, a campaign mode indicates how the sponsor will be identified to users that have selected the display element (e.g., 106). A “normal” mode specifies that after selection of the display element 106, the sponsored publisher's page (e.g., 104) including sponsor content (e.g., branding) is presented. By way of illustration, if the sponsor is a breakfast cereal company, the company's trademark or a brand name of one of their breakfast cereals could be discernably displayed on a portion of the sponsored publisher's website. Alternatively, the sponsors content can be prominently placed on the sponsored publisher's website. In some implementations, campaign parameters include a sponsorship level that allows the sponsor to indicate a level of support in terms of financial support, products, services or other types of support. The sponsorship level can influence how prominently a sponsor's brand is presented on the sponsored publisher's website and/or how frequently the sponsor's brand appears. Sponsors that pay more for sponsorship will most likely expect that their content will occupy a larger area of the sponsored publisher's website, for instance.

An “interstitial” mode specifies that after selection of the display element 106, the sponsor's content 222 (such as an advertisement, for example) is presented. By way of illustration, the sponsor's content 222 can be presented in a new page that is automatically loaded into the user's web browser or the sponsor's content 222 can be presented in an Adobe Flash or Microsoft Silverlight animation, or HTML5 or other rich media technology, that fills some or all of the display area. In this mode, the sponsor's content 222 can be presented for a predetermined amount of time or can require that the user interact with the content 222 in some manner before the sponsored publisher's page 226 is presented. The sponsorship level could be used to specify whether the sponsor's content 222 is interactive or not, for example.

A third mode is “co-sponsored” in which two or more sponsors share sponsorship of the sponsored publisher's website 228 simultaneously. For example, two sponsors that have similar business goals may want to co-sponsor a publisher in order to raise awareness of a product synergy between them. In this mode, selection of the display element 106 causes presentation of the sponsored publisher's page (e.g., 104) including content from both the co-sponsors (e.g., both sponsor's brands). In some implementations, if the level of sponsorship differs between the two sponsors, the sponsor that has a greater level of sponsorship might be more prominently displayed on the sponsored publisher's website than the other sponsor.

The campaign parameters can also include one or more sponsorship triggers that enable a sponsor to indicate when their sponsorship of a sponsored publisher's website should be presented. For example, the time of day and/or date can serve as a trigger. By way of illustration, a given sponsor who manufactures breakfast cereal might only wish to be a sponsor in the morning hours. The presence of one or more parameters in the Uniform Resource Locator (URL) string of the sponsored publisher's page can also serve as a trigger. The geographic location associated with a user's Internet Protocol (IP) address, previously saved address, Global Positioning System (GPS) coordinates, or other geo-locating system, can serve as a demographic trigger, as can the identify of the website in which the display element 106 was placed. Other triggers are possible, including identification systems which provide demographic data, stated or inferred user interests, or behaviors.

The sponsored publisher 204 can have more than one sponsor, as indicated above. In some implementations, more than one sponsor's brand or other content can appear on the sponsored publisher's website if both sponsors' campaigns allow for co-sponsorship with each other. On behalf of its sponsors, the sponsored publisher places display elements (e.g., 106) on other publisher 208's page 220 through an ad network 206 or other means in order to drive traffic to the sponsored publisher's website. In some implementations, the page 220 includes sponsor content. Alternatively, the page 220 does not include sponsor content. In some implementations, the display element 106 includes sponsor content and/or content from an ad network. Alternatively, the display element 106 does not include sponsor content. Selection of the display element 106 drives web traffic to one or more websites, depending on the campaign mode, as describe above. In “normal” mode, the sponsored publisher's page (e.g., 104), including sponsor content such as branding, for example, is presented. In some implementations, only one sponsor's content is presented on the page 104 at a time and that sponsor is selected according to evaluation of campaign parameters for one or more sponsors, or by other means.

In “interstitial mode,” an interstitial page 222 (FIGS. 2A and 2B) is presented as a result of selection of the display element 106. After a predetermined amount of time, the interstitial page 222 is no longer displayed and the sponsored publisher's landing page 226 is presented. Alternatively, the user is required to interact with the interstitial page 222 before the sponsored publisher's landing page 226 is presented. In some implementations, the landing page 226 does not contain sponsor content. In “co-sponsored” mode, selection of the display element 106 causes the presentation of the sponsored publisher's page 228 (FIGS. 2A and 2C) which includes content from two or more sponsors. Other modes are possible, however.

In further implementations, web traffic that arrives at a sponsored publisher's page by means other than selection of a display element will not be presented with any sponsor content. Alternatively, web traffic that arrives at the sponsored publisher's page via one campaign will not be shown sponsorship content from another sponsor. This allows incompatible (e.g., competitor) content to simultaneously sponsor the same content. In yet further implementations, users who do see sponsor content on a sponsored publisher's website are allowed to opt-out from seeing further sponsor content, either by sponsor, or for the entire website.

In some implementations, sponsor content on the sponsored publisher's page can occupy a majority of the page's content. For example, if the sponsored publisher's page (e.g., 104) was a search engine, the search engine controls (query box 116a, query button 116b), and the sponsored publisher's name (e.g., 117) could be arranged to occupy a small area at the top of the page.

FIG. 3 is a block diagram of an example environment 300 in which a sponsorship system can be implemented. The online environment 300 can facilitate the identification and serving of content items, e.g., pages, advertisements, etc., to users. A computer network 310, such as a local area network (LAN), wide area network (WAN), the Internet, or a combination thereof, connects computing devices such as servers for advertisers 302a and 302b, an advertisement management system 304, publishers 306a and 306b, sponsors 318a and 318b, user devices 308a and 308b, and a search engine 312. Although only two advertisers (302a and 302b), two publishers (306a and 306b), two user devices (308a and 308b), and two sponsors (318a and 318b) are shown, the online environment 300 may include many thousands of advertisers, publishers, sponsors, and user devices.

One or more advertisers 302a and/or 302b can directly, or indirectly, enter, maintain, and track advertisement information such as campaign parameters in the advertising management system 304. The advertisements can be in the form of graphical advertisements, such as banner advertisements, text only advertisements, image advertisements, audio advertisements, video advertisements, advertisement gadgets with or without interactive features, advertisements combining one of more of any of such components, etc., or any other type of electronic advertisement document 120. The advertisements may also include embedded information, such as a links, meta-information, and/or machine executable instructions, such as HTML or JavaScript. The advertisement can be submitted, for example, as a single advertisement creative, in a group of related advertisements as an advertisement group, or in multiple advertisement groups that form an advertisement campaign.

A user device, such as user device 308a, can submit a page content request 309 to a publisher or the search engine 312. In some implementations, the page content 311 can be provided to the user device 308a in response to the request 309. The page content can include advertisements provided by the advertisement management system 304, or can include executable instructions, e.g., JavaScript, that can be executed at the user device 308a to request advertisements from the advertisement management system 304. Example user devices 308 include personal computers, mobile communication devices, television set-top boxes, game consoles, etc.

Advertisements can also be provided for the publishers 306. For example, one or more publishers 306a and/or 306b can submit advertisement requests for one or more advertisements to the system 304. The system 304 responds by sending the advertisements to the requesting publisher 306a or 306b for placement on one or more of the publisher's web properties (e.g., websites and other network-distributed content). Alternatively, the system 304 responds by sending the advertisement directly to the user device 308a in response to a user device request for page content 311 from the one or more publishers 306a and/or 306b, typically via instructions embedded in the page content 311 received by the user device 308a from the publishers 306a and/or 306b.

A sponsor, such as sponsor 318a, provides campaign parameters to one or more publishers (e.g., 306a). The campaign parameters include, for example, a reference to an account (e.g., a bank account or credit line) that can be updated by a sponsored publisher or other party to reflect a cost of providing the display element. The sponsored publisher, in turn, places display element advertisements with the advertisement management system 304 in order to drive web traffic to their websites and provide impressions of the sponsors brands. The advertisement management system 304 distributes the advertisements to other publishers (e.g., 306b) and search engines (e.g., 312), for example. In some implementations, the sponsored publisher 306a associates the display element with the sponsor 318a of the display element by encoding data in the display element (e.g., encoding data in as a URL parameter) so that when the display element is selected by a user, the data is transmitted to the sponsored publisher 306a. In some implementations, when the sponsored publisher 306a receives an indication of the selection, the sponsored publisher 306a can update the sponsor 318's account to reflect a cost of having the display element placed by the advertisement management system 304.

The advertisements can include embedding links landing pages, e.g., pages on the advertisers 302 websites, that a user is directed to when the user clicks an ad presented on a publisher website. The advertisement requests can also include content request information. This information can include the content itself (e.g., page or other content document), a category corresponding to the content or the content request (e.g., arts, business, computers, arts-movies, arts-music, etc.), part or all of the content request, content age, content type (e.g., text, graphics, video, audio, mixed media, etc.), geo-location information, etc.

In some implementations, a publisher 306 can combine the requested content with one or more of the advertisements provided by the system 304. This combined page content and advertisements can be sent to the user device 308 that requested the content (e.g., user device 308a) as page content 311 for presentation in a viewer (e.g., a browser or other content display system). The publisher 306 can transmit information about the advertisements back to the advertisement management system 304, including information describing how, when, and/or where the advertisements are to be rendered (e.g., in HTML or JavaScript™).

Publishers 306a and 306b can include general content servers that receive requests for content (e.g., articles, discussion threads, audio, video, graphics, search results, games, software, page listings, information feeds, etc.), and retrieve the requested content in response to the request. For example, content servers related news content providers, retailers, independent blogs, social network sites, or any other entity that provides content over the network 310 can be a publisher.

Advertisements can also be provided through the use of the search engine 312. The search engine 312 can receive queries for search results. In response, the search engine 312 can retrieve relevant search results from an index of documents (e.g., from an index of pages). The search engine 312 can also submit a request for advertisements to the system 304. The request for advertisements may also include the query (as entered or parsed), information based on the query (such as geo-location information, whether the query came from an affiliate and an identifier of such an affiliate), and/or information associated with, or based on, the search results.

The search engine 312 can combine the search results with one or more of the advertisements provided by the system 304. This combined information can then be forwarded to the user device 308 that requested the content as the page content 311. The search results can be maintained as distinct from the advertisements, so as not to confuse the user between paid advertisements and presumably neutral search results.

Advertisements and associated usage data can be stored as advertisement data in an advertisement data store 314. In some implementations, an advertiser 302 can further manage the serving of advertisement by specifying an advertising campaign. The advertising campaign can be stored in campaign data in a campaign data store 316 that can, for example, specify advertising budgets for advertisements, when, where and under what conditions particular advertisements may be served for presentation, etc.

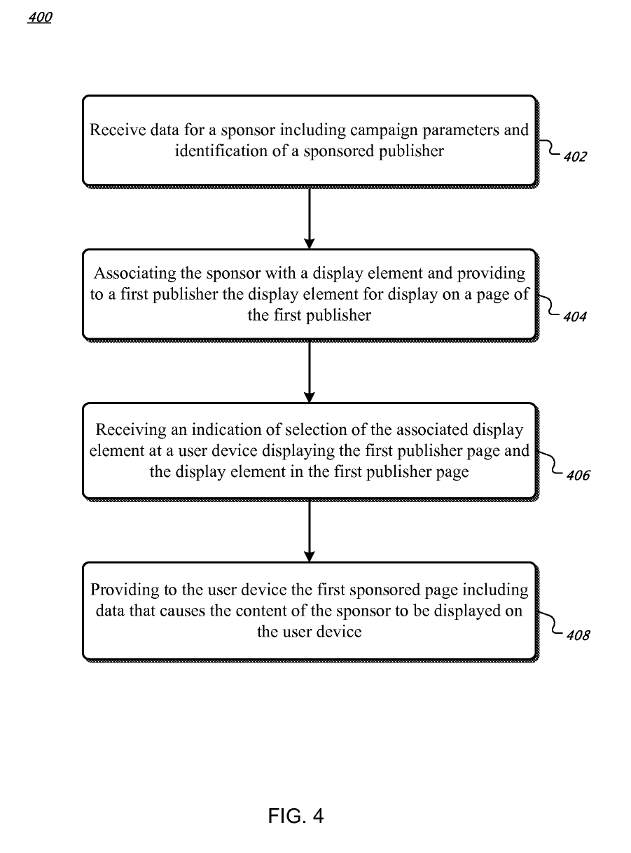

FIG. 4 is a flow diagram of an example technique 400 for sponsorship of a publisher. In step 402, data for a sponsor (e.g., 318a) is received including campaign parameters and identification of a sponsored publisher by the sponsored publisher (e.g., 306a). In step 404, the sponsor is associated with a display element (e.g., 106) which is provided to a first publisher (e.g., 306b) for display on a page of the first publisher. In some implementations, the sponsored publisher makes the association. Alternatively, the advertisement management system 304 can make the association. In step 406, an indication of selection of the associated display element at a user device is received displaying the first publisher page and the display element in the first publisher page. In step 408, providing to the user device, in response to receiving the indication, a first sponsored page of the sponsored publisher selected based on the campaign parameters (e.g., level of support, and so on). The first sponsored page includes data such as HTML or JavaScript code that causes the content of the sponsor to be displayed on the user device.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method, comprising:
receiving data for a sponsor including campaign parameters and identification of a sponsored publisher;
associating the sponsor with a display element and providing to a first publisher the display element for display on a page of the first publisher, wherein the display element does not include content of the sponsor;
receiving an indication of selection of the associated display element at a user device displaying the first publisher page and the display element in the first publisher page; and
providing to the user device, in response to receiving the indication, a first sponsored page of the sponsored publisher selected based on the campaign parameters, the first sponsored page including data that causes the content of the sponsor to be displayed on the user device.

2. The method of claim 1 wherein the campaign parameters include a reference to an account, the method further comprising updating the account to reflect a cost for providing the display element.

3. The method of claim 2, further comprising receiving an indication of selection of a different display element presented on a different publisher's page, and not updating the account to reflect a cost for providing the different display element.

4. The method of claim 1 wherein the displayed first sponsored page is an interstitial page.

5. The method of claim 1 wherein the first sponsored page includes content of the sponsored publisher.

6. The method of claim 1 wherein the first sponsored page includes content of a different second sponsor and content of the sponsored publisher.

7. The method of claim 1 wherein the campaign parameters specify a level of sponsorship.

8. The method of claim 1 wherein providing to the user device the first sponsored page comprises determining a format of the first sponsored page based on one or more of the campaign parameters associated with the sponsor.

9. The method of claim 1 wherein the content of the sponsor is a trademark or a service mark.

10. A computer program product, encoded on a computer-readable storage device, operable to cause data processing apparatus to perform operations comprising:
receiving data for a sponsor including campaign parameters and identification of a sponsored publisher;
associating the sponsor with a display element and providing to a first publisher the display element for display on a page of the first publisher, wherein the display element does not include content of the sponsor;
receiving an indication of selection of the associated display element at a user device displaying the first publisher page and the display element in the first publisher page; and
providing to the user device, in response to receiving the indication, a first sponsored page of the sponsored publisher selected based on the campaign parameters, the first sponsored page including data that causes the content of the sponsor to be displayed on the user device.

11. The program product of claim 10 wherein the campaign parameters include a reference to an account, the program product further comprising updating the account to reflect a cost for providing the display element.

12. The program product of claim 11, wherein the operations further comprise receiving an indication of selection of a different display element presented on a different publisher's page, and not updating the account to reflect a cost for providing the different display element.

13. The program product of claim 10 wherein the displayed first sponsored page is an interstitial page.

14. The program product of claim 10 wherein the first sponsored page includes content of the sponsored publisher.

15. The program product of claim 10 wherein the first sponsored page includes content of a different second sponsor and content of the sponsored publisher.

16. The program product of claim 10 wherein the campaign parameters specify a level of sponsorship.

17. The program product of claim 10 wherein providing to the user device the first sponsored page comprises determining a format of the first sponsored page based on one or more of the campaign parameters associated with the sponsor.

18. The program product of claim 10 wherein the content of the sponsor is a trademark or a service mark.

19. A system comprising:
a computer readable medium including a program product; and
a data processing apparatus configured to execute the program product and perform operations comprising:
receiving data for a sponsor including campaign parameters and identification of a sponsored publisher;
associating the sponsor with a display element and providing to a first publisher the display element for display on a page of the first publisher, wherein the display element does not include content of the sponsor;
receiving an indication of selection of the associated display element at a user device displaying the first publisher page and the display element in the first publisher page; and
providing to the user device, in response to receiving the indication, a first sponsored page of the sponsored publisher selected based on the campaign parameters, the first sponsored page including data that causes the content of the sponsor to be displayed on the user device.

20. The system of claim 19 wherein the campaign parameters include a reference to an account, the system further comprising updating the account to reflect a cost for providing the display element.

21. The system of claim 20, wherein the operations further comprise receiving an indication of selection of a different display element presented on a different publisher's page, and not updating the account to reflect a cost for providing the different display element.

22. The system of claim 19 wherein the displayed first sponsored page is an interstitial page.

23. The system of claim 19 wherein the first sponsored page includes content of the sponsored publisher.

24. The system of claim 19 wherein the first sponsored page includes content of a different second sponsor and content of the sponsored publisher.

25. The system of claim 19 wherein the campaign parameters specify a level of sponsorship.

26. The system of claim 19 wherein providing to the user device the first sponsored page comprises determining a format of the first sponsored page based on one or more of the campaign parameters associated with the sponsor.

27. The system of claim 19 wherein the content of the sponsor is a trademark or a service mark.
